(19) United States
(12) Patent Application Publication
(10) Pub. No.: US 2026/0112300 A1
(43) Pub. Date: Apr. 23, 2026

(54) DISPLAY APPARATUS, METHOD OF DRIVING DISPLAY PANEL USING THE SAME AND ELECTRONIC APPARATUS INCLUDING THE SAME

(71) Applicant: Samsung Display Co., LTD., Yongin-si (KR)

(72) Inventors: SEOKHA HONG, Yongin-si (KR); JUSEO KIM, Yongin-si (KR); JONG-WOONG PARK, Yongin-si (KR); KANGHEE LEE, Yongin-si (KR); MIYOUNG JOO, Yongin-si (KR)

(21) Appl. No.: 19/362,432

(22) Filed: Oct. 19, 2025

(30) Foreign Application Priority Data
Oct. 21, 2024 (KR) 10-2024-0143744

(51) Int. Cl. G09G 3/20

(52) U.S. Cl. CPC G09G 3/2007; G09G 2310/027; G09G 2320/046; G09G 2320/0626; G09G 2360/16

(57) ABSTRACT

A display apparatus includes a display panel, a data driver and a driving controller. The data driver outputs a data voltage to the display panel. The driving controller includes a deterioration compensator which compensates a first input grayscale value based on a stress accumulation value to generate a first output grayscale value and a stress accumulator which accumulates the first output grayscale value to generate the stress accumulation value. The stress accumulator determines the stress accumulation value based on a luminance control mode, a luminance setting value, an on-pixel ratio and the first output grayscale value.

This application claims priority to Korean Patent Application No. 10-2024-0143744, filed on Oct. 21, 2024, and all the benefits accruing therefrom under 35 U.S. C. § 119, the content of which in its entirety is herein incorporated by reference.

### BACKGROUND

### 1. Field

Embodiments of the invention relate to a display apparatus, a method of driving a display panel using the display apparatus and an electronic apparatus including the display apparatus. More particularly, embodiments of the invention relate to a display apparatus with enhanced display quality, a method of driving a display panel using the display apparatus and an electronic apparatus including the display apparatus.

### 2. Description of the Related Art

Generally, a display apparatus includes a display panel and a display panel driver. The display panel displays an image based on input image data. The display panel may include a plurality of gate lines, a plurality of data lines and a plurality of pixels. The display panel driver may include a gate driver, a data driver and a driving controller. The gate driver outputs gate signals to the gate lines. The data driver outputs data voltages to the data lines. The driving controller controls an operation of the gate driver and an operation of the data driver.

### SUMMARY

In a display apparatus including a display panel, a driving controller may accumulate stresses of pixels of the display panel based on grayscale values of the pixels of the display panel and compensate deteriorations of pixels using the stresses. When accuracies of accumulation values of the stresses are decreased in the deterioration compensation, the accuracy of the deterioration compensation may be decreased and accordingly, a display quality of the display panel may be decreased.

Embodiments of the invention provide a display apparatus enhancing accuracies of stress accumulation values of pixels according to grayscale values of the pixels, enhancing an accuracy of deterioration compensation and enhancing a display quality of a display panel.

Embodiments of the invention also provide a method of driving a display panel using the display apparatus.

Embodiments of the invention also provide an electronic apparatus including the display apparatus.

In an embodiment of a display apparatus according to the invention, the display apparatus includes a display panel, a data driver and a driving controller. In such an embodiment, the data driver outputs a data voltage to the display panel. In such an embodiment, the driving controller includes a deterioration compensator which compensates a first input grayscale value based on a stress accumulation value to generate a first output grayscale value and a stress accumulator which accumulates the first output grayscale value to generate the stress accumulation value. In such an embodiment, the stress accumulator determines the stress accumulation value based on a luminance control mode, a luminance setting value, an on-pixel ratio and the first output grayscale value.

In an embodiment, the luminance control mode may include a first mode in which the display panel has a constant luminance regardless of the on-pixel ratio at a same luminance setting value and a same input grayscale value.

In an embodiment, the stress accumulator may determine the stress accumulation value based on the luminance setting value and the first output grayscale value and regardless of the on-pixel ratio when the luminance control mode is the first mode.

In an embodiment, the luminance control mode may include a second mode in which a luminance of the display panel decreases as the on-pixel ratio increases at a same luminance setting value and a same input grayscale value.

In an embodiment, the stress accumulator may determine the stress accumulation value based on the luminance setting value and the first output grayscale value and regardless of the on-pixel ratio when the luminance control mode is the second mode. In such an embodiment, the stress accumulator may determine the stress accumulation value without applying a weight to the first output grayscale value for a first grayscale range when the luminance control mode is the second mode. In such an embodiment, the stress accumulator may determine the stress accumulation value by applying a weight to the first output grayscale value for a second grayscale range having a grayscale value greater than a grayscale value of the first grayscale range when the luminance control mode is the second mode.

In an embodiment, the luminance control mode may include a third mode in which a luminance of the display panel decreases as the on-pixel ratio increases and a slope of a luminance decrease is varied according to a range of the on-pixel ratio at a same luminance setting value and a same input grayscale value.

In an embodiment, the luminance may decrease as the on-pixel ratio increases at the same luminance setting value and the same input grayscale value for a first on-pixel ratio range when the luminance control mode is the third mode. In such an embodiment, the luminance may decrease as the on-pixel ratio increases at the same luminance setting value and the same input grayscale value for a second on-pixel ratio range when the luminance control mode is the third mode. In such an embodiment, the on-pixel ratio in the second on-pixel ratio range may be greater than the on-pixel ratio in the first on-pixel ratio range. In such an embodiment, an absolute value of a second luminance decrease slope in the second on-pixel ratio range may be greater than an absolute value of a first luminance decrease slope in the first on-pixel ratio range.

In an embodiment, the luminance may decrease as the on-pixel ratio increases at the same luminance setting value and the same input grayscale value for a third on-pixel ratio range when the luminance control mode is the third mode. In such an embodiment, the on-pixel ratio in the third on-pixel ratio range may be greater than the on-pixel ratio in the second on-pixel ratio range. In such an embodiment, an absolute value of a third luminance decrease slope in the third on-pixel ratio range may be less than the absolute value of the second luminance decrease slope in the second on-pixel ratio range.

In an embodiment, the display panel may have a constant luminance regardless of the on-pixel ratio at the same input grayscale value for a first luminance setting value when the luminance control mode is the third mode. In such an embodiment, the luminance of the display panel may decrease as the on-pixel ratio increases at the same input grayscale value for a second luminance setting value when the luminance control mode is the third mode. In such an embodiment, the second luminance setting value may be greater than the first luminance setting value. In such an embodiment, a first on-pixel ratio range of the second luminance setting value in the third mode may have a first luminance decrease slope, a second on-pixel ratio range of the second luminance setting value in the third mode may have a second luminance decrease slope, and a third on-pixel ratio range of the second luminance setting value in the third mode may have a third luminance decrease slope. In such an embodiment, the on-pixel ratio of the second on-pixel ratio range may be greater than the on-pixel ratio of the first on-pixel ratio range, and the on-pixel ratio of the third on-pixel ratio range may be greater than the on-pixel ratio of the second on-pixel ratio range. In such an embodiment, an absolute value of the second luminance decrease slope may be greater than an absolute value of the first luminance decrease slope, and an absolute value of the third luminance decrease slope may be less than the absolute value of the second luminance decrease slope.

In an embodiment, the stress accumulator may determine the stress accumulation value based on a stress profile which is generated based on measured luminance data for a plurality of measuring luminance setting values, a plurality of measuring grayscale values and a plurality of measuring on-pixel ratios.

In an embodiment, the measured luminance data may be measured for three or more measuring luminance setting values, three or more measuring grayscale values and three or more measuring on-pixel ratios.

In an embodiment, the luminance control mode may include a first mode in which the display panel has a constant luminance regardless of the on-pixel ratio at a same luminance setting value and a same input grayscale value, a second mode in which a luminance of the display panel decreases as the on-pixel ratio increases at the same luminance setting value and the same input grayscale value, and a third mode in which a luminance of the display panel decreases as the on-pixel ratio increases and a slope of a luminance decrease is varied according to a range of the on-pixel ratio at the same luminance setting value and the same input grayscale value. In such an embodiment, the stress accumulator may be configured to determine the stress accumulation value based on a first stress profile, which is generated based on first measured luminance data for a plurality of first measuring luminance setting values, a plurality of first measuring grayscale values and a plurality of first measuring on-pixel ratios when the luminance control mode is the first mode.

In an embodiment, the stress accumulator may determine the stress accumulation value based on a second stress profile, which is generated based on second measured luminance data for a plurality of second measuring luminance setting values, a plurality of second measuring grayscale values and a plurality of second measuring on-pixel ratios when the luminance control mode is the second mode.

In an embodiment, the stress accumulator may determine the stress accumulation value based on a third stress profile, which is generated based on third measured luminance data for a plurality of third measuring luminance setting values, a plurality of third measuring grayscale values and a plurality of third measuring on-pixel ratios when the luminance control mode is the third mode.

In an embodiment, the driving controller may further include a luminance adjuster which compensates a second input grayscale value based on the luminance control mode, the luminance setting value and the on-pixel ratio to output a second output grayscale value.

In an embodiment, the driving controller may further include an image analyzer which analyzes input image data to determine the on-pixel ratio and outputs the on-pixel ratio to the stress accumulator and the luminance adjuster.

In an embodiment of a method of driving a display panel according to the invention, the method includes compensating a first input grayscale value based on a stress accumulation value to generate a first output grayscale value, accumulating the first output grayscale value to generate the stress accumulation value, generating a data voltage based on the first output grayscale value and displaying an image based on the data voltage. In such an embodiment, the stress accumulation value is determined based on a luminance control mode, a luminance setting value, an on-pixel ratio and the first output grayscale value.

In an embodiment, the luminance control mode may include a first mode in which the display panel has a constant luminance regardless of the on-pixel ratio at a same luminance setting value and a same input grayscale value, a second mode in which a luminance of the display panel decreases as the on-pixel ratio increases at the same luminance setting value and the same input grayscale value and a third mode in which a luminance of the display panel decreases as the on-pixel ratio increases and a slope of a luminance decrease is varied according to a range of the on-pixel ratio at the same luminance setting value and the same input grayscale value.

In an embodiment, the stress accumulation value may be determined based on the luminance setting value and the first output grayscale value and regardless of the on-pixel ratio when the luminance control mode is the first mode. In such an embodiment, the stress accumulation value may be determined based on the luminance setting value and the first output grayscale value and regardless of the on-pixel ratio when the luminance control mode is the second mode. In such an embodiment, the stress accumulation value may be determined without applying a weight to the first output grayscale value for a first grayscale range when the luminance control mode is the second mode. In such an embodiment, the stress accumulation value may be determined by applying a weight to the first output grayscale value for a second grayscale range having a grayscale value greater than a grayscale value of the first grayscale range when the luminance control mode is the second mode. In such an embodiment, the stress accumulation value may be determined based on a stress profile which is generated based on measured luminance data for a plurality of measuring luminance setting values, a plurality of measuring grayscale values and a plurality of measuring on-pixel ratios.

In an embodiment of an electronic apparatus according to the invention, the electronic apparatus includes a display panel, a data driver, a driving controller and a processor. In such an embodiment, the data driver outputs a data voltage to the display panel. In such an embodiment, the driving controller controls the data driver. In such an embodiment, the processor outputs input image data and an input control signal to the driving controller. In such an embodiment, the driving controller includes a deterioration compensator which compensates a first input grayscale value based on a stress accumulation value to generate a first output grayscale value and a stress accumulator which accumulates the first output grayscale value to generate the stress accumulation value. In such an embodiment, the stress accumulator determines the stress accumulation value based on a luminance control mode, a luminance setting value, an on-pixel ratio and the first output grayscale value.

According to embodiments of the display apparatus, the method of driving the display panel using the display apparatus and the electronic apparatus including the display apparatus, as described herein, the stress accumulator of the display apparatus may determine the stress accumulation value based on the luminance control mode, the luminance setting value, the on-pixel ratio and the first output grayscale value.

In such embodiments, the luminance control mode may include the first mode, the second mode and the third mode and the stress accumulator may determine the stress accumulation value varied according to the first mode, the second mode and the third mode.

Thus, the accuracy of the stress accumulation value may be enhanced such that the accuracy of the deterioration compensation may be enhanced and the display quality of the display panel may be enhanced.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a block diagram illustrating a driving controller of FIG. 1;

FIG. 3 is a graph illustrating a luminance of a display panel of FIG. 1 according to an on-pixel ratio in a first mode, a second mode and a third mode;

FIG. 4 is a graph illustrating a luminance of the display panel of FIG. 1 according to the on-pixel ratio in the first mode;

FIG. 5 is a graph illustrating a luminance of the display panel of FIG. 1 according to the on-pixel ratio in the second mode;

FIG. 6 is a graph illustrating a luminance of the display panel of FIG. 1 according to the on-pixel ratio in the third mode;

FIG. 7 is a diagram illustrating a loading effect of the display panel of FIG. 1;

FIG. 8 is a graph illustrating an example of an output grayscale value for an input grayscale value of the display apparatus of FIG. 1 in the first mode and the second mode;

FIG. 9 is a graph illustrating an example of a luminance measurement of the display panel of FIG. 1 to determine a stress accumulation value in the third mode;

FIGS. 10A to 10D are diagrams illustrating examples of the luminance measurement of the display panel of FIG. 1 to determine the stress accumulation value in the third mode;

FIG. 11 is a graph illustrating an example of a luminance measurement of a display panel of a display apparatus according to an embodiment of the invention to determine a stress accumulation value in a first mode;

FIG. 12 is a graph illustrating an example of the luminance measurement of the display panel of the display apparatus of FIG. 11 to determine a stress accumulation value in a second mode;

FIG. 13 is a graph illustrating an example of the luminance measurement of the display panel of the display apparatus of FIG. 11 to determine a stress accumulation value in a third mode;

FIG. 14 is a block diagram illustrating an electronic apparatus according to an embodiment of the invention;

FIG. 15 is a diagram illustrating an example in which the electronic apparatus of FIG. 14 is implemented as a smartphone;

FIG. 16 is a diagram illustrating an example in which the electronic apparatus of FIG. 14 is implemented as a monitor; and

FIG. 17 is a block diagram illustrating an electronic apparatus according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an. ” “Or” means “and/or. ” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

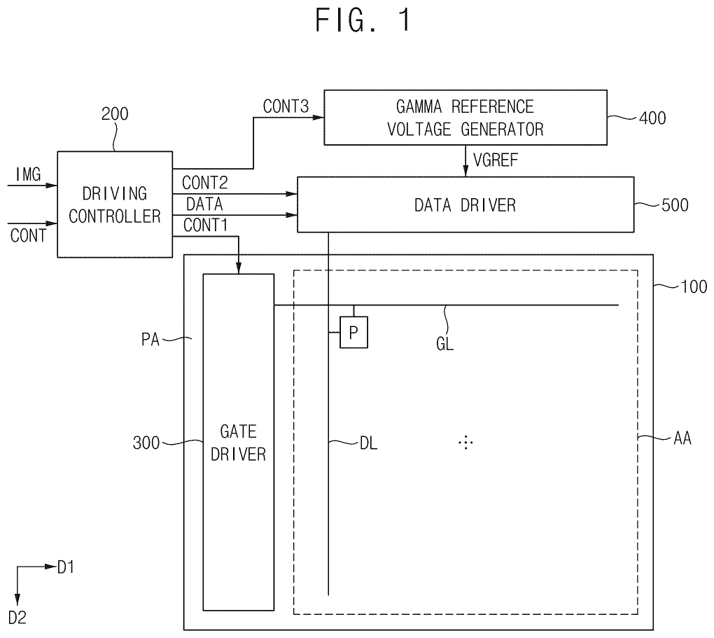

FIG. 1 is a block diagram illustrating a display apparatus according to an embodiment of the invention.
referring to FIG. 1, an embodiment of the display apparatus includes a display panel 100 and a display panel driver. The display panel driver drives the display panel 100. The display panel driver includes a driving controller 200, a gate driver 300, a gamma reference voltage generator 400 and a data driver 500.

In an embodiment, for example, the driving controller 200 and the data driver 500 may be integrally formed with each other as a single module or chip. In an embodiment, for example, the driving controller 200, the gamma reference voltage generator 400 and the data driver 500 may be integrally formed with each other as single module or chip. A driving module including at least the driving controller 200 and the data driver 500 which are integrally formed with each other may be called to a timing controller embedded data driver (TED).

The display panel 100 has a display region AA on which an image is displayed and a peripheral region PA adjacent to the display region AA.

The display panel 100 includes a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 may receive input image data IMG and an input control signal CONT from an external apparatus (e.g., an application processor). In an embodiment, for example, the input image data IMG may include red image data, green image data and blue image data. In an embodiment, for example, the input image data IMG may include white image data. In an embodiment, for example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals driving the gate lines GL in response to the first control signal CONT1 received from the driving controller 200. The gate driver 300 may output the gate signals to the gate lines GL. In an embodiment, for example, the gate driver 300 may sequentially output the gate signals to the gate lines GL. In an embodiment, for example, the gate driver 300 may be mounted on the peripheral region PA of the display panel 100. In an embodiment, for example, the gate driver 300 may be integrated on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500.

The data driver 500 may receive the second control signal CONT2 and the data signal DATA from the driving controller 200, and receives the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

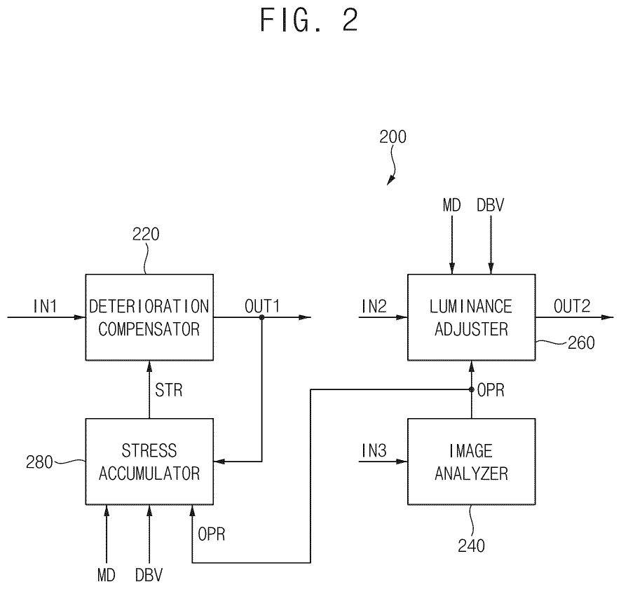

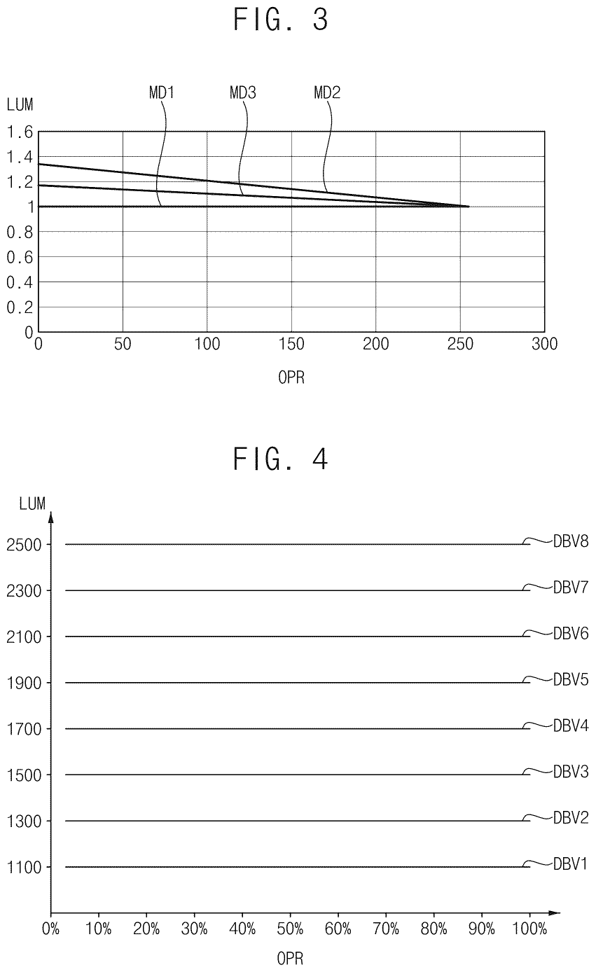

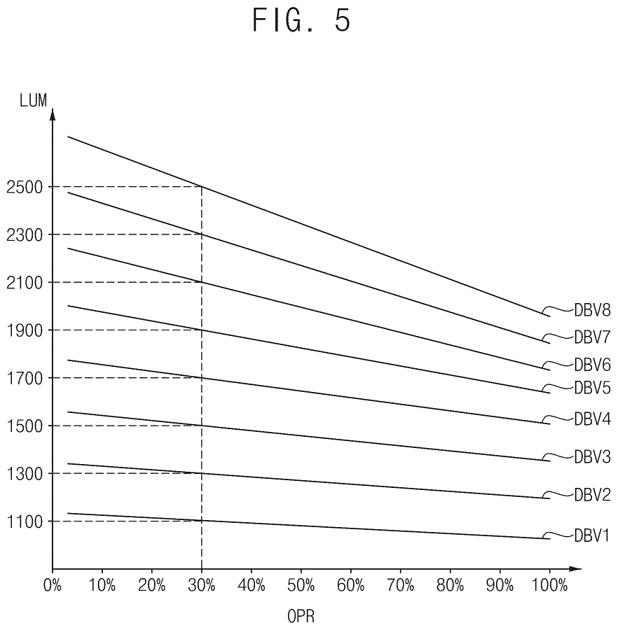

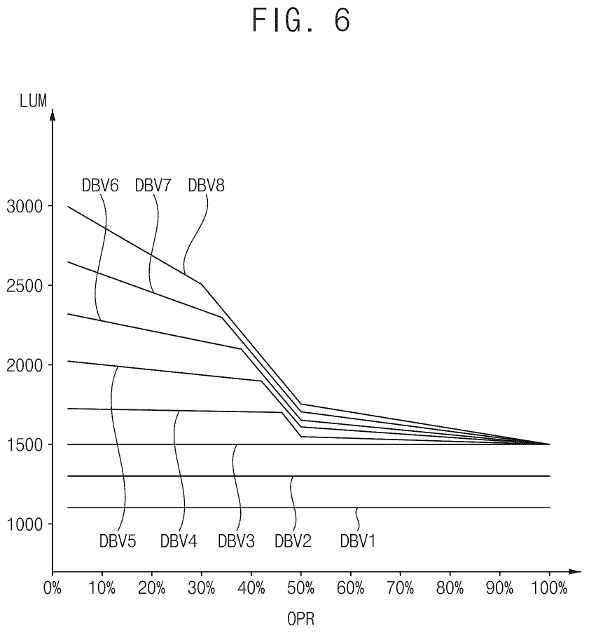

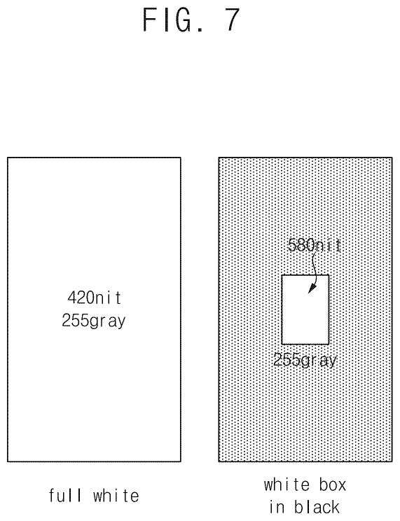

FIG. 2 is a block diagram illustrating the driving controller 200 of FIG. 1. FIG. 3 is a graph illustrating a luminance of the display panel 100 of FIG. 1 according to an on-pixel ratio OPR in a first mode MD1, a second mode MD2 and a third mode MD3. FIG. 4 is a graph illustrating a luminance of the display panel 100 of FIG. 1 according to the on-pixel ratio OPR in the first mode MD1. FIG. 5 is a graph illustrating a luminance of the display panel 100 of FIG. 1 according to the on-pixel ratio OPR in the second mode MD2. FIG. 6 is a graph illustrating a luminance of the display panel 100 of FIG. 1 according to the on-pixel ratio OPR in the third mode MD3. FIG. 7 is a diagram illustrating a loading effect of the display panel 100 of FIG. 1.

Referring to FIGS. 1 to 7, in an embodiment, the driving controller 200 includes a deterioration compensator 220 that compensates a first input grayscale value IN1 based on a stress accumulation value STR to generate a first output grayscale value OUT1 and a stress accumulator 280 that accumulates the first output grayscale value OUT1 to generate the stress accumulation value STR.

The stress accumulator 280 determines the stress accumulation value STR based on a luminance control mode MD, a luminance setting value DBV, an on-pixel ratio OPR and the first output grayscale value OUT1.

The driving controller 200 may further include a luminance adjuster 260 that compensates a second input grayscale value IN2 based on the luminance control mode MD, the luminance setting value DBV and the on-pixel ratio OPR to output a second output grayscale value OUT2.

The luminance adjuster 260 may output the second output grayscale value OUT2 varied based on the luminance control mode MD including the first to third modes MD1 to MD3.

In an embodiment, for example, the luminance adjuster 260 may output the second output grayscale value OUT2 such that a luminance LUM of the display panel 100 represents a waveform of FIG. 4 in the first mode MD1.

In an embodiment, for example, the luminance adjuster 260 may output the second output grayscale value OUT2 such that a luminance LUM of the display panel 100 represents a waveform of FIG. 5 in the second mode MD2.

In an embodiment, for example, the luminance adjuster 260 may output the second output grayscale value OUT2 such that a luminance LUM of the display panel 100 represents a waveform of FIG. 6 in the third mode MD3.

The driving controller 200 may further include an image analyzer 240 that analyzes the input image data IMG to determine the on-pixel ratio OPR and outputs the on-pixel ratio OPR to the stress accumulator 280 and the luminance adjuster 260. An input of the image analyzer 240 may be the same as the first input grayscale value IN1 which is an input of the deterioration compensator 220. Alternatively, the input of the image analyzer 240 may be the same as the second input grayscale value IN2 which is an input of the luminance adjuster 260.

Although the first input grayscale value IN1, the second input grayscale value IN2 and the third input grayscale value IN3 mean input grayscale values of the input image data IMG, the first input grayscale value IN1, the second input grayscale value IN2 and the third input grayscale value IN3 may be changed while passing through stages of compensation blocks in the driving controller 200 so that the first input grayscale value IN1, the second input grayscale value IN2 and the third input grayscale value IN3 are indicated as respective reference symbols independent from the input image data IMG.

The luminance setting value DBV may mean a luminance value corresponding to a maximum grayscale value. In an embodiment, for example, when the luminance setting value DBV is set to 1000 nit and the maximum grayscale value is 255, the display panel 100 may display a luminance of 1000 nit for the grayscale value of 255. In an embodiment, for example, when the luminance setting value DBV is set to 100 nit and the maximum grayscale value is 255, the display panel 100 may display a luminance of 100 nit for the grayscale value of 255.

The luminance setting value DBV may be manually set by a user or automatically set according to an ambient environment (e.g., external luminance) The on-pixel ratio OPR may mean a ratio of turned-on pixels among total pixels of the display panel 100. In an embodiment, for example, when all pixels are turned on in a grayscale value of 255, the first input grayscale value IN1 may be 255 and the on-pixel ratio OPR may be 100%. In an embodiment, for example, when half of all pixels are turned on in a grayscale value of 255, the first input grayscale value IN1 may be 255 and the on-pixel ratio OPR may be 50%.

In an embodiment, for example, when all pixels are turned on in a grayscale value of 127, the first input grayscale value IN1 may be 127 and the on-pixel ratio OPR may be 100%. According to another embodiment, when all pixels are turned on in a grayscale value of 127, the on-pixel ratio OPR may be perceived as 50%. In an embodiment, for example, when half of all pixels are turned on in a grayscale value of 127, the first input grayscale value IN1 may be 127 and the on-pixel ratio OPR may be 50%. According to another embodiment, when half of all pixels are turned on in a grayscale value of 127, the on-pixel ratio OPR may be perceived as 25%.

The luminance control mode may include the first mode MD1 in which the display panel 100 has a constant luminance LUM regardless of the on-pixel ratio OPR at a same luminance setting value and a same input grayscale value. In an embodiment, for example, the first mode MD1 may be referred to as a flat gamma mode.

In FIG. 4, for example, a first luminance setting value DBV1 is 1100 nit, a second luminance setting value DBV2 is 1300 nit, a third luminance setting value DBV3 is 1500 nit, a fourth luminance setting value DBV4 is 1700 nit, a fifth luminance setting value DBV5 is 1900 nit, a sixth luminance setting value DBV6 is 2100 nit, a seventh luminance setting value DBV1 is 2300 nit and an eighth luminance setting value DBV8 is 2500 nit.

FIG. 4 represents the luminance LUM according to the on-pixel ratio OPR in the first mode MD1. In an embodiment, for example, when the luminance setting value DBV is the first luminance setting value DBV1, the luminance LUM of the display panel 100 may be about 1100 nit regardless of the on-pixel ratio OPR. When the luminance setting value DBV is the second luminance setting value DBV2, the luminance LUM of the display panel 100 may be about 1300 nit regardless of the on-pixel ratio OPR. When the luminance setting value DBV is the eighth luminance setting value DBV8, the luminance LUM of the display panel 100 may be about 2500 nit regardless of the on-pixel ratio OPR.

The luminance control mode may include the second mode MD2 in which the luminance LUM of the display panel 100 decreases as the on-pixel ratio OPR increases at a same luminance setting value and a same input grayscale value. In an embodiment, for example, the second mode MD2 may be referred to as a long range uniformity mode.

In FIG. 5, for example, a first luminance setting value DBV1 is 1100 nit, a second luminance setting value DBV2 is 1300 nit, a third luminance setting value DBV3 is 1500 nit, a fourth luminance setting value DBV4 is 1700 nit, a fifth luminance setting value DBV5 is 1900 nit, a sixth luminance setting value DBV6 is 2100 nit, a seventh luminance setting value DBV1 is 2300 nit and an eighth luminance setting value DBV8 is 2500 nit.

FIG. 5 represents the luminance LUM according to the on-pixel ratio OPR in the second mode MD2. In an embodiment, for example, the luminance LUM may decrease as the on-pixel ratio OPR increases in the second mode MD2. A slope of a luminance decrease (or a luminance decrease rate) may be constant in a specific luminance setting value DBV.

In an embodiment, for example, when the luminance setting value DBV is the first luminance setting value DBV1, the luminance LUM of the display panel 100 may decrease as the on-pixel ratio OPR increases. In an embodiment, for example, when the luminance setting value DBV is the first luminance setting value DBV1 and the on-pixel ratio OPR is about 30%, the luminance LUM of the display panel 100 may be set to be about 1100 nit. When the luminance setting value DBV is the first luminance setting value DBV1 and the on-pixel ratio OPR is less than 30%, the luminance LUM of the display panel 100 may be greater than 1100 nit. When the luminance setting value DBV is the first luminance setting value DBV1 and the on-pixel ratio OPR is greater than 30%, the luminance LUM of the display panel 100 may be less than 1100 nit.

In an embodiment, for example, when the luminance setting value DBV is the second luminance setting value DBV2, the luminance LUM of the display panel 100 may decrease as the on-pixel ratio OPR increases. In an embodiment, for example, when the luminance setting value DBV is the second luminance setting value DBV2 and the on-pixel ratio OPR is about 30%, the luminance LUM of the display panel 100 may be set to be about 1300 nit. When the luminance setting value DBV is the second luminance setting value DBV2 and the on-pixel ratio OPR is less than 30%, the luminance LUM of the display panel 100 may be greater than 1300 nit. When the luminance setting value DBV is the second luminance setting value DBV2 and the on-pixel ratio OPR is greater than 30%, the luminance LUM of the display panel 100 may be less than 1300 nit.

In an embodiment, for example, when the luminance setting value DBV is the eighth luminance setting value DBV8, the luminance LUM of the display panel 100 may decrease as the on-pixel ratio OPR increases. In an embodiment, for example, when the luminance setting value DBV is the eighth luminance setting value DBV8 and the on-pixel ratio OPR is about 30%, the luminance LUM of the display panel 100 may be set to be about 2500 nit. When the luminance setting value DBV is the eighth luminance setting value DBV8 and the on-pixel ratio OPR is less than 30%, the luminance LUM of the display panel 100 may be greater than 2500 nit. When the luminance setting value DBV is the eighth luminance setting value DBV8 and the on-pixel ratio OPR is greater than 30%, the luminance LUM of the display panel 100 may be less than 2500 nit.

The luminance control mode may include the third mode MD3 in which the luminance LUM of the display panel 100 decreases as the on-pixel ratio OPR increases and the slope of the luminance decrease may be varied according to a range of the on-pixel ratio OPR at the same luminance setting value and the same input grayscale value. In an embodiment, for example, the third mode MD3 may be referred to as a flat gamma Z mode.

As shown in FIG. 3, the luminance of the third mode MD3 is greater than the luminance of the first mode MD1 in a low on-pixel ratio range and the luminance of the second mode MD2 is greater than the luminance of the third mode MD3 in the low on-pixel ratio range.

In FIG. 6, for example, a first luminance setting value DBV1 is 1100 nit, a second luminance setting value DBV2 is 1300 nit, a third luminance setting value DBV3 is 1500 nit, a fourth luminance setting value DBV4 is 1700 nit, a fifth luminance setting value DBV5 is 1900 nit, a sixth luminance setting value DBV6 is 2100 nit, a seventh luminance setting value DBV1 is 2300 nit and an eighth luminance setting value DBV8 is 2500 nit.

FIG. 6 represents the luminance LUM according to the on-pixel ratio OPR in the third mode MD3. In an embodiment, for example, the luminance LUM may decrease as the on-pixel ratio OPR increases in the third mode MD3. The slope of the luminance decrease may be varied according to the range of the on-pixel ratio OPR in the third mode MD3.

In the third mode MD3, the display panel 100 may have a constant luminance LUM regardless of the on-pixel ratio OPR at a same input grayscale value for the first to third luminance setting values DBV1 to DBV3 in the third mode MD3.

In the third mode MD3, however, the luminance LUM of the display panel 100 may decrease as the on-pixel ratio OPR increases at a same input grayscale value for the fourth to eighth luminance setting values DBV4 to DBV8 in the third mode MD3.

As shown in the graphs for the fourth to eighth luminance setting values DBV4 to DBV8 in FIG. 6, the luminance LUM may decrease as the on-pixel ratio OPR increases at a same luminance setting value and a same input grayscale value for a first on-pixel ratio range in the third mode MD3. The luminance LUM may decrease as the on-pixel ratio OPR increases at a same luminance setting value and a same input grayscale value for a second on-pixel ratio range in the third mode MD3. The on-pixel ratio OPR in the second on-pixel ratio range may be greater than the on-pixel ratio OPR in the first on-pixel ratio range. An absolute value of a second luminance decrease slope in the second on-pixel ratio range may be greater than an absolute value of a first luminance decrease slope in the first on-pixel ratio range.

As shown in the graphs for the fourth to eighth luminance setting values DBV4 to DBV8 in FIG. 6, the luminance LUM may decrease as the on-pixel ratio OPR increases at the same luminance setting value and the same input grayscale value for a third on-pixel ratio range in the third mode MD3. The on-pixel ratio OPR in the third on-pixel ratio range may be greater than the on-pixel ratio OPR in the second on-pixel ratio range. An absolute value of a third luminance decrease slope in the third on-pixel ratio range may be less than the absolute value of the second luminance decrease slope in the second on-pixel ratio range.

In an embodiment, for example, when the luminance setting value DBV is the first luminance setting value DBV1, the luminance LUM of the display panel 100 may be constant regardless of the on-pixel ratio OPR. However, the invention may not be limited thereto. When the luminance setting value DBV is the first luminance setting value DBV1, the luminance LUM of the display panel 100 may decrease as the on-pixel ratio OPR increases.

In an embodiment, for example, when the luminance setting value DBV is the second luminance setting value DBV2, the luminance LUM of the display panel 100 may be constant regardless of the on-pixel ratio OPR. However, the invention may not be limited thereto. When the luminance setting value DBV is the second luminance setting value DBV2, the luminance LUM of the display panel 100 may decrease as the on-pixel ratio OPR increases.

In an embodiment, for example, when the luminance setting value DBV is the seventh luminance setting value DBV7, the luminance LUM of the display panel 100 may decrease as the on-pixel ratio OPR increases. When the luminance setting value DBV is the seventh luminance setting value DBV7, the slope of the luminance decrease may be varied according to the range of the on-pixel ratio OPR. In an embodiment, for example, as the on-pixel ratio OPR increases, the luminance LUM may decrease in a first luminance decrease slope in a first on-pixel ratio range. As the on-pixel ratio OPR increases, the luminance LUM may decrease in a second luminance decrease slope in a second on-pixel ratio range having an on-pixel ratio OPR greater than an on-pixel ratio OPR of the first on-pixel ratio range. As the on-pixel ratio OPR increases, the luminance LUM may decrease in a third luminance decrease slope in a third on-pixel ratio range having an on-pixel ratio OPR greater than the on-pixel ratio OPR of the second on-pixel ratio range. When the luminance setting value DBV is the seventh luminance setting value DBV7, an absolute value of the second luminance decrease slope may be greater than an absolute value of the first luminance decrease slope. In addition, when the luminance setting value DBV is the seventh luminance setting value DBV7, an absolute value of the third luminance decrease slope may be less than the absolute value of the second luminance decrease slope.

In an embodiment, for example, when the luminance setting value DBV is the eighth luminance setting value DBV8, the luminance LUM of the display panel 100 may decrease as the on-pixel ratio OPR increases. When the luminance setting value DBV is the eighth luminance setting value DBV8, the slope of the luminance decrease may be varied according to the range of the on-pixel ratio OPR. In an embodiment, for example, as the on-pixel ratio OPR increases, the luminance LUM may decrease in a first luminance decrease slope in a first on-pixel ratio range. As the on-pixel ratio OPR increases, the luminance LUM may decrease in a second luminance decrease slope in a second on-pixel ratio range having an on-pixel ratio OPR greater than an on-pixel ratio OPR of the first on-pixel ratio range. As the on-pixel ratio OPR increases, the luminance LUM may decrease in a third luminance decrease slope in a third on-pixel ratio range having an on-pixel ratio OPR greater than the on-pixel ratio OPR of the second on-pixel ratio range. When the luminance setting value DBV is the eighth luminance setting value DBV8, an absolute value of the second luminance decrease slope may be greater than an absolute value of the first luminance decrease slope. In addition, when the luminance setting value DBV is the eighth luminance setting value DBV8, an absolute value of the third luminance decrease slope may be less than the absolute value of the second luminance decrease slope.

FIG. 7 illustrates a loading effect which means that the luminance is varied according to a load of the display panel 100 for the same input grayscale value.

In a left portion of FIG. 7, all of the pixels of the display panel 100 have a grayscale value of 255 and a white luminance of about 420 nit. In a right portion of FIG. 7, a background of the display panel 100 is black and a white box having a grayscale value of 255 is disposed in the black background. The white box has a white luminance of about 580 nit.

As the on-pixel ratio OPR (or the load) decreases, the luminance corresponding to the grayscale value of 255 may increase.

In the first mode MD1, as described above, the loading effect may be compensated such that the display panel 100 may have a constant luminance LUM regardless of the on-pixel ratio OPR for a same grayscale value.

In the third mode MD3, as described above, the loading effect may not be compensated such that the luminance LUM of the display panel 100 may decrease as the on-pixel ratio OPR increases for the same grayscale value. However, the third mode MD3 may not be limited to a case in which the loading effect is not compensated. The third mode MD3 may include various cases in which the luminance LUM decreases as the on-pixel ratio OPR increases.

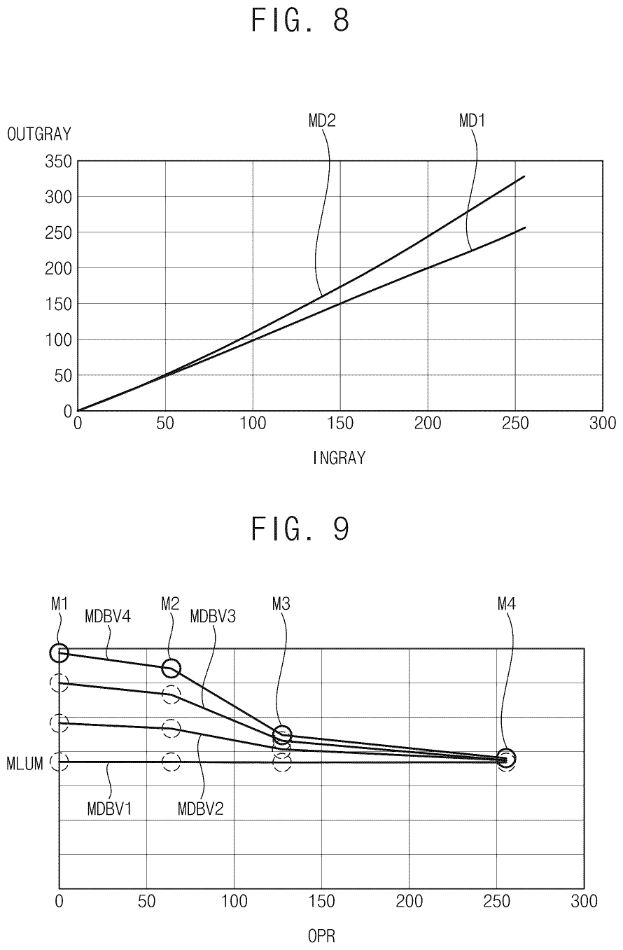

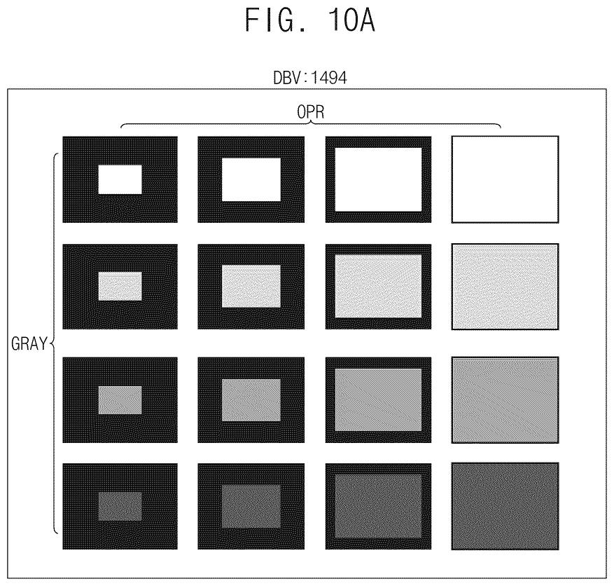

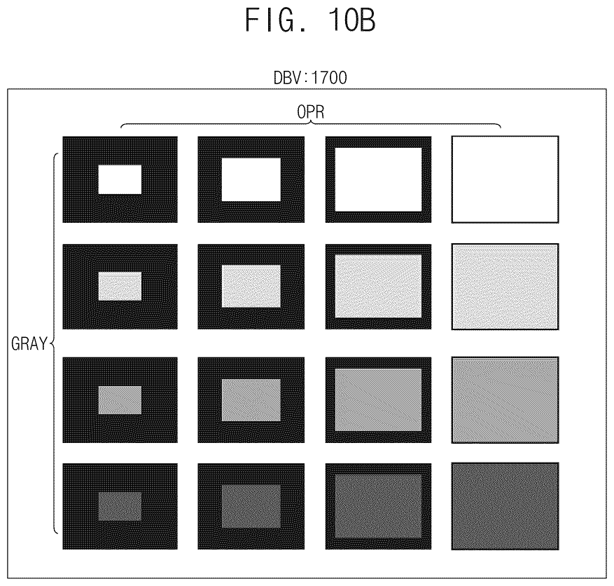

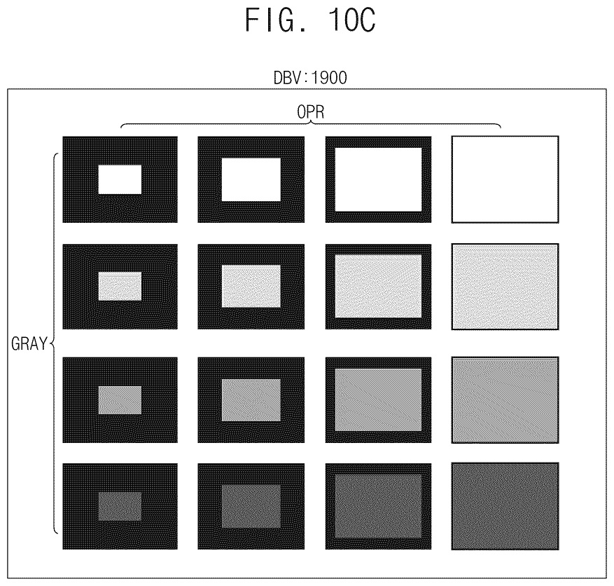

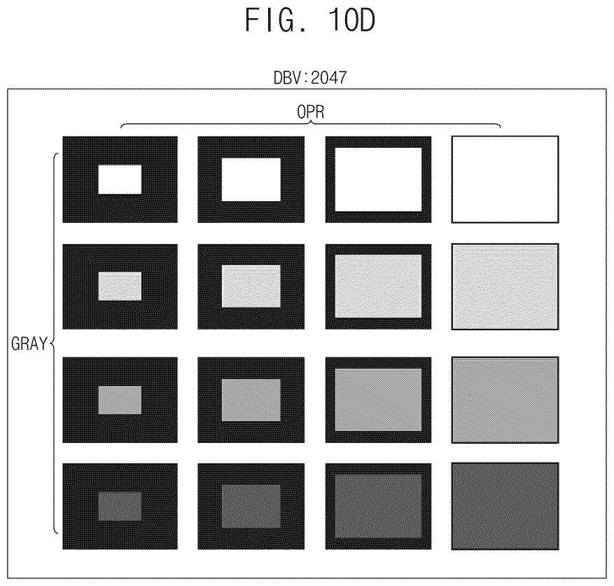

FIG. 8 is a graph illustrating an example of an output grayscale value OUTGRAY for an input grayscale value INGRAY of the display apparatus of FIG. 1 in the first mode MD1 and the second mode MD2. FIG. 9 is a graph illustrating an example of a luminance measurement of the display panel 100 of FIG. 1 to determine a stress accumulation value STR in the third mode MD3. FIGS. 10A to 10D are diagrams illustrating examples of the luminance measurement of the display panel 100 of FIG. 1 to determine the stress accumulation value STR in the third mode MD3.

Referring to FIGS. 1 to 10D, in the first mode MD1, the stress accumulator 280 may determine the stress accumulation value STR based on the luminance setting value DBV and the first output grayscale value OUT1 and regardless of the on-pixel ratio OPR.

When the display apparatus operates in the first mode MD1, the driving controller 200 may determine the stress accumulation value STR based on the luminance setting value DBV and the first output grayscale value OUT1 without a scaling in the first mode MD1 since the input grayscale value INGRAY and the output grayscale value OUTGRAY are substantially the same as each other in the first mode MD1 as shown in FIG. 8.

In the second mode MD2, the stress accumulator 280 may determine the stress accumulation value STR based on the luminance setting value DBV and the first output grayscale value OUT1 and regardless of the on-pixel ratio OPR.

When the display apparatus operates in the second mode MD2, the driving controller 200 may compensate the stress accumulation value STR such that the input grayscale value INGRAY and the output grayscale value OUTGRAY are substantially the same as each other in a low grayscale range and the output grayscale value OUTGRAY is greater than the input grayscale value INGRAY in a high grayscale range in the second mode MD2 as shown in FIG. 8.

In the second mode MD2, the stress accumulator 280 may determine the stress accumulation value STR without applying a weight to the first output grayscale value OUT1 for a first grayscale range (the low grayscale range). A method of a stress accumulation for the first grayscale range (the low grayscale range) in the second mode MD2 may be substantially the same as a method of a stress accumulation in the first mode MD1.

In the second mode MD2, the stress accumulator 280 may determine the stress accumulation value STR by applying a weight to the first output grayscale value OUT1 for a second grayscale range (the high grayscale range) having a grayscale value greater than a grayscale value of the first grayscale range (the low grayscale range). In an embodiment, for example, the stress accumulation value STR may be determined by multiplying the weight, which is greater than one, to the first output grayscale value OUT1.

In the third mode MD3, the stress accumulator 280 may determine the stress accumulation value STR based on a stress profile which is generated based on measured luminance data MLUM for a plurality of measuring luminance setting values, a plurality of measuring grayscale values and a plurality of measuring on-pixel ratios.

As shown in FIG. 6, the luminance for the input grayscale value varies greatly depending on the on-pixel ratio OPR and the luminance setting value DBV so that it is very difficult to predict an overall operation of the driving controller 200 in the third mode MD3.

Thus, separate measured data may be obtained to improve an accuracy of the stress accumulation value STR in the third mode MD3.

Portions marked with circles in FIG. 9 mean luminance measuring points. As shown in FIG. 9, luminances MLUM may be measured at four different measuring on-pixel ratios for a first measuring luminance setting value MDBV1. Luminances MLUM may be measured at four different measuring on-pixel ratios for a second measuring luminance setting value MDBV2. Luminances MLUM may be measured at four different measuring on-pixel ratios for a third measuring luminance setting value MDBV3. Luminances MLUM may be measured at four different measuring on-pixel ratios for a fourth measuring luminance setting value MDBV4. Four measuring points for the fourth measuring luminance setting value MDBV4 are indicated as M1, M2, M3 and M4 in FIG. 9.

In FIG. 9, the measured luminances MLUM for sixteen measuring points according to four measuring luminance setting values and four measuring on-pixel ratio are illustrated.

Measured luminances MLUM for sixty four measuring points may be obtained when the operation of FIG. 9 is repeated for four different measuring grayscale values.

The stress profile may be generated based on the measured luminance data MLUM for the sixty four measuring points in the third mode MD3. The stress accumulator 280 may determine the stress accumulation value STR using the stress profile in the third mode MD3.

In an embodiment, for example, the measured luminance data MLUM may be measured for three or more measuring luminance setting values, three or more measuring grayscale values and three or more measuring on-pixel ratios. In FIGS. 9 to 10D, the sixty four measured luminance data MLUM are measured for four measuring luminance setting values, four measuring grayscale values and four measuring on-pixel ratios.

FIG. 10A illustrates a process of obtaining sixteen measured luminance data MLUM by varying the measuring on-pixel ratios in four different values and the measuring grayscale values in four different values for the first measuring luminance setting value (e.g., 1494).

FIG. 10B illustrates a process of obtaining sixteen measured luminance data MLUM by varying the measuring on-pixel ratios in four different values and the measuring grayscale values in four different values for the second measuring luminance setting value (e.g., 1700).

FIG. 10C illustrates a process of obtaining sixteen measured luminance data MLUM by varying the measuring on-pixel ratios in four different values and the measuring grayscale values in four different values for the third measuring luminance setting value (e.g., 1900).

FIG. 10D illustrates a process of obtaining sixteen measured luminance data MLUM by varying the measuring on-pixel ratios in four different values and the measuring grayscale values in four different values for the fourth measuring luminance setting value (e.g., 2047).

According to an embodiment, the stress accumulator 280 of the display apparatus may determine the stress accumulation value STR based on the luminance control mode MD, the luminance setting value DBV, the on-pixel ratio OPR and the first output grayscale value OUT1.

The luminance control mode MD may include the first mode MD1, the second mode MD2 and the third mode MD3 and the stress accumulator 280 may determine the stress accumulation value STR varied according to the first mode MD1, the second mode MD2 and the third mode MD3.

Thus, the accuracy of the stress accumulation value STR may be enhanced such that the accuracy of the deterioration compensation may be enhanced and the display quality of the display panel 100 may be enhanced.

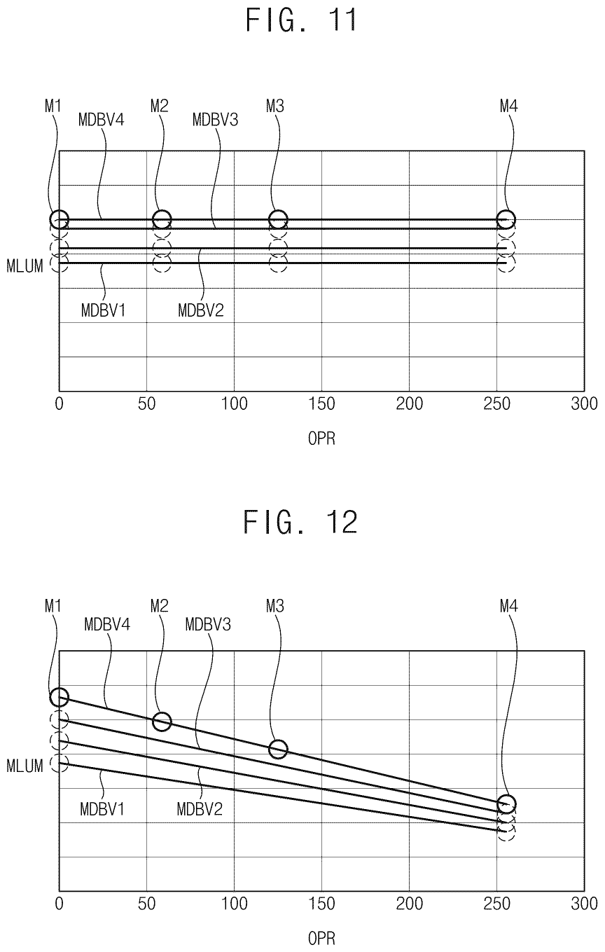

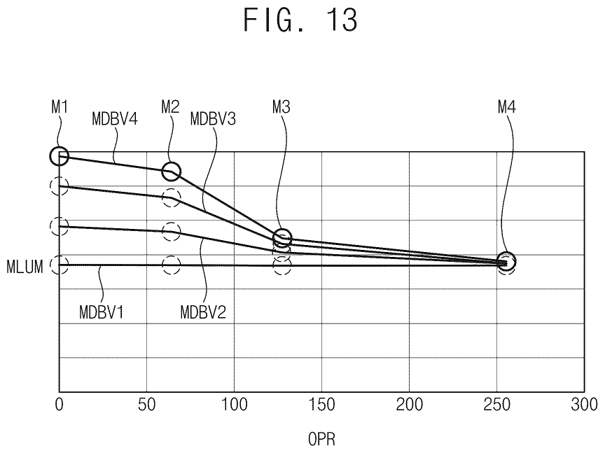

FIG. 11 is a graph illustrating an example of a luminance measurement of a display panel 100 of a display apparatus according to an embodiment of the invention to determine a stress accumulation value STR in a first mode MD1. FIG. 12 is a graph illustrating an example of the luminance measurement of the display panel 100 of the display apparatus of FIG. 11 to determine a stress accumulation value STR in a second mode MD2. FIG. 13 is a graph illustrating an example of the luminance measurement of the display panel 100 of the display apparatus of FIG. 11 to determine a stress accumulation value STR in a third mode MD3.

The display apparatus shown in FIGS. 11 to 13 is substantially the same as the display apparatus described above referring to FIGS. 1 to 10D except for a method of stress accumulating in the first mode MD1 and the second mode MD2. Thus, the same reference numerals will be used to refer to the same or like parts as those described above with reference to FIGS. 1 to 10D and any repetitive detailed description thereof will be omitted or simplified.

Referring to FIGS. 1 to 8 and 11 to 13, in an embodiment, the driving controller 200 includes a deterioration compensator 220 that compensates a first input grayscale value IN1 based on a stress accumulation value STR to generate a first output grayscale value OUT1 and a stress accumulator 280 that accumulates the first output grayscale value OUT1 to generate the stress accumulation value STR.

The stress accumulator 280 determines the stress accumulation value STR based on a luminance control mode MD, a luminance setting value DBV, an on-pixel ratio OPR and the first output grayscale value OUT1.

The driving controller 200 may further include a luminance adjuster 260 that compensates a second input grayscale value IN2 based on the luminance control mode MD, the luminance setting value DBV and the on-pixel ratio OPR to output a second output grayscale value OUT2.

The luminance adjuster 260 may output the second output grayscale value OUT2 varied according to the luminance control mode MD including first to third modes MD1 to MD3.

In the present embodiment, a stress profile may be generated for the first mode MD1 and the second mode MD2, similarly to the third mode MD3 of the previous embodiment explained referring to FIGS. 1 to 10D.

In the first mode MD1, the stress accumulator 280 may determine the stress accumulation value STR based on a first stress profile which is generated based on first measured luminance data for a plurality of first measuring luminance setting values, a plurality of first measuring grayscale values and a plurality of first measuring on-pixel ratios.

Portions marked with circles mean luminance measuring points in FIG. 11. As shown in FIG. 11, luminances MLUM may be measured at four different measuring on-pixel ratios for a first measuring luminance setting value MDBV1. Luminances MLUM may be measured at four different measuring on-pixel ratios for a second measuring luminance setting value MDBV2. Luminances MLUM may be measured at four different measuring on-pixel ratios for a third measuring luminance setting value MDBV3. Luminances MLUM may be measured at four different measuring on-pixel ratios for a fourth measuring luminance setting value MDBV4. Four measuring points for the fourth measuring luminance setting value MDBV4 are indicated as M1, M2, M3 and M4 in FIG. 11.

In FIG. 11, the measured luminances MLUM for sixteen measuring points according to four measuring luminance setting values and four measuring on-pixel ratio are illustrated.

Measured luminances MLUM for sixty four measuring points may be obtained when the operation of FIG. 11 is repeated for four different measuring grayscale values.

The first stress profile may be generated based on the measured luminance data MLUM for the sixty four measuring points in the first mode MD1. The stress accumulator 280 may determine the stress accumulation value STR using the first stress profile in the first mode MD1.

In the second mode MD2, the stress accumulator 280 may determine the stress accumulation value STR based on a second stress profile which is generated based on second measured luminance data for a plurality of second measuring luminance setting values, a plurality of second measuring grayscale values and a plurality of second measuring on-pixel ratios.

Portions marked with circles mean luminance measuring points in FIG. 12. As shown in FIG. 12, luminances MLUM may be measured at four different measuring on-pixel ratios for a first measuring luminance setting value MDBV1. Luminances MLUM may be measured at four different measuring on-pixel ratios for a second measuring luminance setting value MDBV2. Luminances MLUM may be measured at four different measuring on-pixel ratios for a third measuring luminance setting value MDBV3. Luminances MLUM may be measured at four different measuring on-pixel ratios for a fourth measuring luminance setting value MDBV4. Four measuring points for the fourth measuring luminance setting value MDBV4 are indicated as M1, M2, M3 and M4 in FIG. 12.

In FIG. 12, the measured luminances MLUM for sixteen measuring points according to four measuring luminance setting values and four measuring on-pixel ratio are illustrated.

Measured luminances MLUM for sixty four measuring points may be obtained when the operation of FIG. 12 is repeated for four different measuring grayscale values.

The second stress profile may be generated based on the measured luminance data MLUM for the sixty four measuring points in the second mode MD2. The stress accumulator 280 may determine the stress accumulation value STR using the second stress profile in the second mode MD2.

In the third mode MD3, the stress accumulator 280 may determine the stress accumulation value STR based on a third stress profile which is generated based on third measured luminance data for a plurality of third measuring luminance setting values, a plurality of third measuring grayscale values and a plurality of third measuring on-pixel ratios.

Portions marked with circles mean luminance measuring points in FIG. 13. As shown in FIG. 13, luminances MLUM may be measured at four different measuring on-pixel ratios for a first measuring luminance setting value MDBV1. Luminances MLUM may be measured at four different measuring on-pixel ratios for a second measuring luminance setting value MDBV2. Luminances MLUM may be measured at four different measuring on-pixel ratios for a third measuring luminance setting value MDBV3. Luminances MLUM may be measured at four different measuring on-pixel ratios for a fourth measuring luminance setting value MDBV4. Four measuring points for the fourth measuring luminance setting value MDBV4 are indicated as M1, M2, M3 and M4 in FIG. 13.

In FIG. 13, the measured luminances MLUM for sixteen measuring points according to four measuring luminance setting values and four measuring on-pixel ratio are illustrated.

Measured luminances MLUM for sixty four measuring points may be obtained when the operation of FIG. 13 is repeated for four different measuring grayscale values.

The third stress profile may be generated based on the measured luminance data MLUM for the sixty four measuring points in the third mode MD3. The stress accumulator 280 may determine the stress accumulation value STR using the third stress profile in the third mode MD3.

According to an embodiment, the stress accumulator 280 of the display apparatus may determine the stress accumulation value STR based on the luminance control mode MD, the luminance setting value DBV, the on-pixel ratio OPR and the first output grayscale value OUT1.

The luminance control mode MD may include the first mode MD1, the second mode MD2 and the third mode MD3 and the stress accumulator 280 may determine the stress accumulation value STR varied according to the first mode MD1, the second mode MD2 and the third mode MD3.

Thus, the accuracy of the stress accumulation value STR may be enhanced such that the accuracy of the deterioration compensation may be enhanced and the display quality of the display panel 100 may be enhanced.

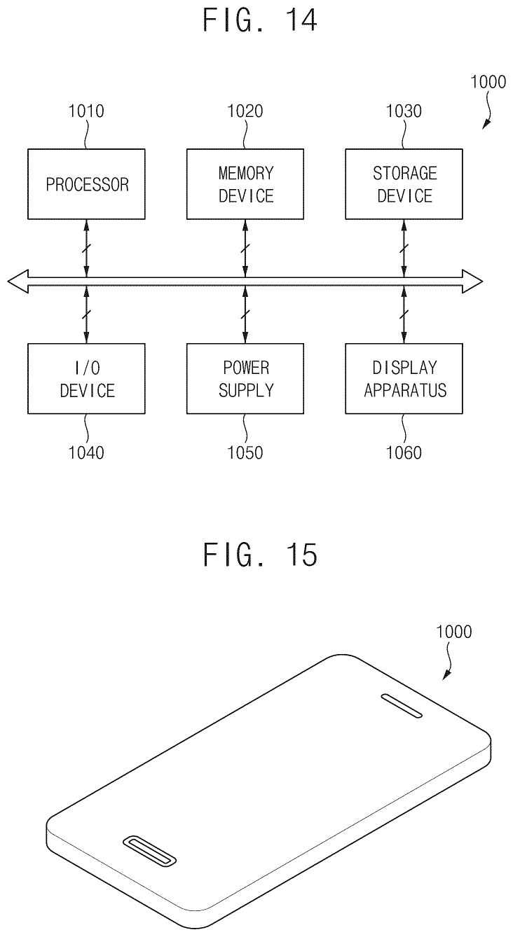

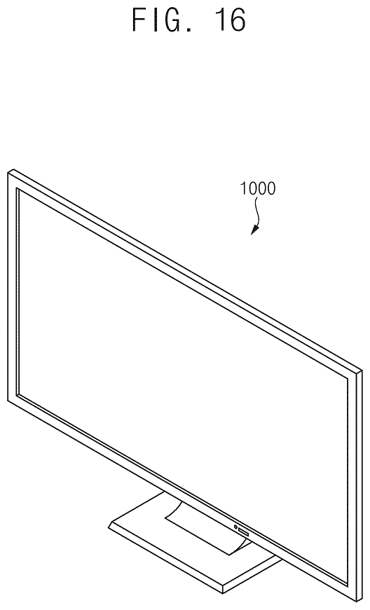

FIG. 14 is a block diagram illustrating an electronic apparatus 1000 according to an embodiment of the invention. FIG. 15 is a diagram illustrating an example in which the electronic apparatus 1000 of FIG. 14 is implemented as a smartphone. FIG. 16 is a diagram illustrating an example in which the electronic apparatus 1000 of FIG. 14 is implemented as a monitor.

Referring to FIGS. 14 to 16, an embodiment of the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 15, the electronic apparatus 1000 may be implemented as a smartphone. In an embodiment, as illustrated in FIG. 16, the electronic apparatus 1000 may be implemented as a monitor. However, the electronic apparatus 1000 is not limited thereto. In an embodiment, for example, the electronic apparatus 1000 may be implemented as a television, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

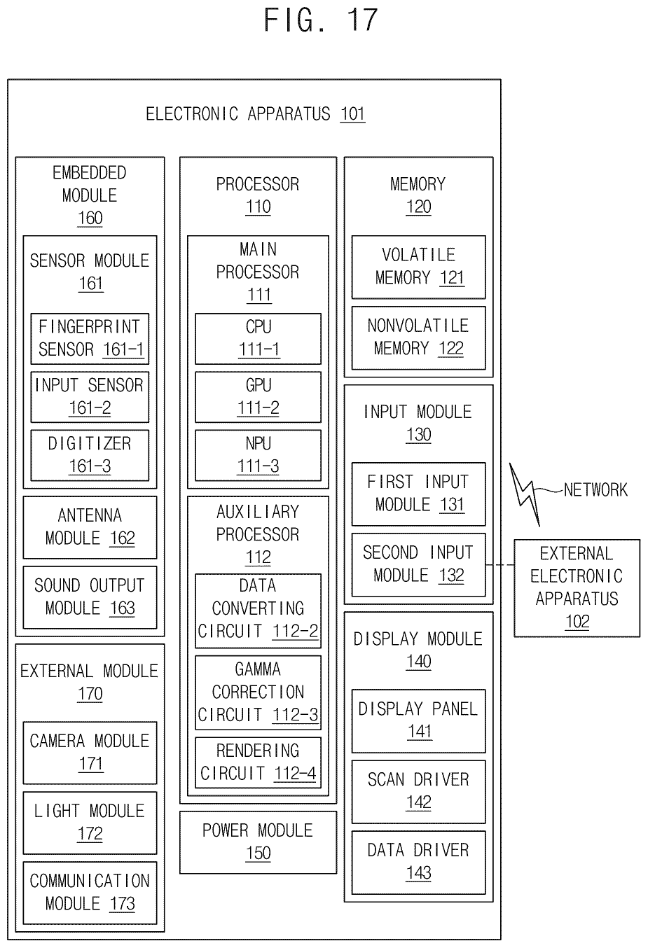

FIG. 17 is a block diagram illustrating an electronic apparatus 101 according to an embodiment of the invention.

Referring to FIGS. 1 to 17, the electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. In an embodiment, for example, when the user selects a camera icon displayed on the display panel 141, the processor 110 obtains a user input through an input sensor 161-2 and activates a camera module 171. The processor 110 transfers image data corresponding to a captured image obtained through the camera module 171 to the display module 140. The display module 140 may display an image corresponding to the captured image through the display panel 141.

In an embodiment, when a personal information authentication is executed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

In an embodiment, when a music streaming icon displayed on the display module 140 is selected, the processor 110 obtains a user input through the input sensor 161-2 and activates a music streaming application stored in the memory 120. When a music execution command is input in the music streaming application, the processor 110 activates a sound output module 163 to provide sound information corresponding to the music execution command to the user.

In the above, the operation of the electronic apparatus 101 is briefly described. Hereinafter, a configuration of the electronic apparatus 101 is described in detail. Some of elements of the electronic apparatus 101 described later may be integrated and provided as one element, or one element may be separated as two or more elements.

The electronic apparatus 101 may communicate with an external electronic apparatus 102 through a network (e.g., a short-range wireless communication network or a long-range wireless communication network). According to an embodiment, the electronic apparatus 101 may include the processor 110, the memory 120, the input module 130, the display module 140, a power module 150, an embedded module 160, and an external module 170. According to an embodiment, in the electronic apparatus 101, at least one of the above-described elements may be omitted or one or more other apparatus may be added. According to an embodiment, some of the above-described elements (e.g., the sensor module 161, an antenna module 162 or the sound output module 163) may be integrated into another element (e.g., the display module 140).

The processor 110 may execute software to control at least one other element (e.g., hardware or software element) of the electronic apparatus 101 connected to the processor 110 and to perform various data processing or operations. According to an embodiment, as at least part of the data processing or the operations, the processor 110 may store receive instructions or data from other elements (e.g. the input module 130, the sensor module 161 or a communication module 173) in a volatile memory 121, may process the instructions or data stored in the volatile memory 121 and may store result data of the processing in a nonvolatile memory 122.

The processor 110 may include a main processor 111 and an auxiliary processor 112. The main processor 111 may include at least one selected from a central processing unit (CPU) 111-1 and an application processor (AP). The main processor 111 may further include at lest one selected from a graphic processing unit (GPU) 111-2, a communication processor (CP) and an image signal processor (ISP). The main processor 111 may further include a neural processing unit (NPU) 111-3. The neural network processing unit 111-3 is a processor specialized in processing an artificial intelligence model. The artificial intelligence model may be generated through a machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN) and a deep Q-networks or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element (e.g., a single chip) or each may be implemented as independent elements (e.g., in a plurality of chips).

The auxiliary processor 112 may include a controller. The controller may include an interface conversion circuit and a timing control circuit. The controller receives an image signal from the main processor 111, converts a data format of the image signal to meet interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and may compensate the image data such that the image is displayed with a desired luminance according to characteristics of the electronic apparatus 101 or a user setting or may convert the image data to reduce a power consumption or compensate for afterimages. The gamma correction circuit 112-3 may convert the image data or a gamma reference voltage such that the image displayed on the electronic apparatus 101 has desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g., the main processor 111 or the controller). At least one of the data converting circuit 112-2, the gamma correction circuit 112-3 and the rendering circuit 112-4 may be integrated into a data driver 143 to be described later.

The memory 120 may store various data used by at least one element (e.g., the processor 110 or the sensor module 161) of the electronic apparatus 101 and input data or output data for commands related thereto. The memory 120 may include at least one of the volatile memory 121 and the nonvolatile memory 122.

The input module 130 may receive commands or data used to the elements (e.g., the processor 110, the sensor module 161 or the sound output module 163) of the electronic apparatus 101 from the outside of the electronic apparatus 101 (e.g., the user or the external electronic apparatus 102).

The input module 130 may include a first input module 131 for receiving commands or data from the user and a second input module 132 for receiving commands or data from the external electronic apparatus 102. The first input module 131 may include a microphone, a mouse, a keyboard, a key (e.g., a button) or a pen (e.g., a passive pen or an active pen). The second input module 132 may support a designated protocol capable of connecting to the external electronic apparatus 102 by wire or wirelessly. According to an embodiment, the second input module 132 may include a high definition multimedia interface (HDMI), a universal serial bus (USB) interface, an SD card interface or an audio interface. The second input module 132 may include a connector physically connected to the external electronic apparatus 102, for example, an HDMI connector, a USB connector, an SD card connector, or an audio connector (e.g., a headphone connector).

The display module 140 visually provides information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light emitting display panel or an inorganic light emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be mounted on the display panel 141 as a driving chip. Alternatively, the scan driver 142 may be integrated on the display panel 141. In an embodiment, for example, the scan driver 142 may include an amorphous silicon TFT gate driver circuit (ASG) integrated on the display panel 141, a low temperature polycrystalline silicon (LTPS) TFT gate driver circuit integrated on the display panel 141, or an oxide semiconductor TFT gate driver circuit (OSG) integrated on the display panel 141. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. Alternatively, the light emission driver and the scan driver 142 may be integrally formed.

The data driver 143 receives a control signal from the controller and converts the image data into an analog voltage (e.g., the data voltage) and output the data voltages to the display panel 141 in response to the control signal.

The data driver 143 may be integrated into another element (e.g., the controller). The functions of the interface conversion circuit and the timing control circuit of the controller described above may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell or a fuel cell. The power module 150 may include a power management integrated circuit (PMIC). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor and a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure bio signals such as a blood pressure, a moisture, or a body fat. In an embodiment, for example, when a user touches a part of his body to a sensor layer or a sensing panel and does not move for a certain period of time, the input sensor 161-2 may detect the bio signal based on a change in an electric field caused by the part of the body so that the display module 140 may output user's desired information.

The digitizer 161-3 may generate a data value corresponding to the coordinate information input by the pen. The digitizer 161-3 generates an amount of electromagnetic change by the input as a data value. The digitizer 161-3 may detect an input by the passive pen or transmit/receive data to/from the active pen.

At least one of the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one selected from the fingerprint sensor 161-1, the input sensor 161-2 and the digitizer 161-3, for example, the digitizer 161-3, may be disposed under the display panel 141.

At least two selected from the fingerprint sensor 161-1, the input sensor 161-2 and the digitizer 161-3 may be integrated into the sensing panel through the same process. When at least two selected from the fingerprint sensor 161-1, the input sensor 161-2 and the digitizer 161-3 are integrated into the sensing panel, the sensing panel may be disposed between the display panel 141 and a window disposed over an upper surface of the display panel 141. According to an embodiment, the sensing panel may be disposed on the window. The invention may not be limited to a position of the sensing panel.

At least one selected from the fingerprint sensor 161-1, the input sensor 161-2 and the digitizer 161-3 may be embedded in the display panel 141. In an embodiment, for example, at least one selected from the fingerprint sensor 161-1, the input sensor 161-2 and the digitizer 161-3 is formed simultaneously with the display panel 141 through a process of forming elements included in the display panel 141 (e.g., light emitting elements, transistors, etc.).

In addition, the sensor module 161 may generate an electrical signal or a data value corresponding to an internal state or an external state of the electronic apparatus 101. In an embodiment, for example, the sensor module 161 may further include a gesture sensor, a gyro sensor, a barometric pressure sensor, a magnetic sensor, an acceleration sensor, a grip sensor, a proximity sensor, a color sensor, an infrared (IR) sensor, a biosensor, a temperature sensor, a humidity sensor or an illuminance sensor.

The antenna module 162 may include one or more antennas for transmitting a signal or power to outside or receiving a signal or power from outside. According to an embodiment, the antenna module 162 may transmit a signal to an external electronic apparatus 102 or receive a signal from an external electronic apparatus 102 through an antenna suitable for a communication method. An antenna pattern of the antenna module 162 may be integrated with an element of the display module 140 (e.g., the display panel 141) or the input sensor 161-2.

The sound output module 163 is a device for outputting sound signals to the outside of the electronic apparatus 101. In an embodiment, for example, the sound output module 163 may include a speaker used for general purposes such as playing multimedia or recording and a receiver used exclusively for receiving a call. According to an embodiment, the receiver may be formed integrally with or separately from the speaker. A sound output pattern of the sound output module 163 may be integrated with the display module 140.

The camera module 171 may capture still images and moving images. According to an embodiment, the camera module 171 may include one or more lenses, an image sensor or an image signal processor. The camera module 171 may further include an infrared camera capable of determining a presence or an absence of a user, the user's location and the user's gaze.

The light module 172 may provide a light. The light module 172 may include a light emitting diode or a xenon lamp. The light module 172 may operate in conjunction with the camera module 171 or operate independently.

The communication module 173 may support establishment of a wired or wireless communication channel between the electronic apparatus 101 and the external electronic apparatus 102 and communication through the established communication channel. The communication module 173 may include one or both of a wireless communication module such as a cellular communication module, a short-distance wireless communication module, or a global navigation satellite system (GNSS) communication module and a wired communication module such as a local area network (LAN) communication module, or a power line communication module. The communication module 173 may communicate with the external electronic apparatus 102 through a short-range communication network such as Bluetooth, WiFi direct or infrared data association (IrDA) or a long-distance communication network such as a cellular network, the Internet, or a computer network (e.g., LAN or WAN). The various types of communication modules 173 described above may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. In an embodiment, for example, the processor 110 may generate image data corresponding to input data applied through a mouse or an active pen, and output the generated image data to the display module 140 or the processor 110 may generate command data corresponding to the input data and output the generated command data to the camera module 171 or the light module 172. When input data is not received from the input module 130 for a certain period of time, the processor 110 converts an operation mode of the electronic apparatus 101 into a low power mode or a sleep mode so that a power consumption of the electronic apparatus 101 may be reduced.

The processor 110 outputs commands or data to the display module 140, the sound output module 163, the camera module 171 or the light module 172 based on sensed data received from the sensor module 161. In an embodiment, for example, the processor 110 may compare authentication data applied by the fingerprint sensor 161-1 with authentication data stored in the memory 120, and then execute an application according to the comparison result. The processor 110 may execute commands or output corresponding image data to the display module 140 based on the sensed data sensed by the input sensor 161-2 or the digitizer 161-3. In an embodiment where the sensor module 161 includes a temperature sensor, the processor 110 may receive temperature data for the temperature measured from the sensor module 161 and may further perform luminance correction on the image data based on the temperature data.

The processor 110 may receive determined data about the presence or the absence of the user, the user's location and the user's gaze from the camera module 171. The processor 110 may further perform luminance correction on the image data based on the determined data. In an embodiment, for example, the processor 110, which determines the presence or the absence of the user through an input from the camera module 171, may display image data having the luminance corrected by the data converting circuit 112-2 or the gamma correction circuit 112-3 to the display module 140.

Some of the above elements may be connected to each other through a communication method between peripheral devices such as a bus, a general purpose input/output (GPIO), a serial peripheral interface (SPI), a mobile industry processor interface (MIPI), or an ultra path interconnect (UPI) link to exchange signals (e.g., commands or data) with each other. The processor 110 may communicate with the display module 140 through an agreed interface. In an embodiment, for example, the processor 110 may communicate with the display module 140 through any one of the above communication methods. The present invention may not be limited to the above communication methods.

The electronic apparatus 101 according to various embodiments disclosed in the disclosure may be various types of apparatuses. In an embodiment, for example, the electronic apparatus 101 may include at least one of a portable communication apparatus (e.g., a smart phone), a computer apparatus, a portable multimedia apparatus, a portable medical apparatus, a camera, a wearable device and a home appliance. The electronic apparatus 101 according to the embodiment of the disclosure may not be limited to the aforementioned apparatuses.

In an embodiment, for example, the display panel 100 of FIG. 1 may correspond to the display panel 141 of FIG. 17. In an embodiment, for example, the driving controller 200 of FIG. 1 may correspond to the controller of the auxiliary processor 112 of FIG. 17. In an embodiment, for example, the gate driver 300 of FIG. 1 may correspond to the scan driver 142 of FIG. 17. In an embodiment, for example, the data driver 500 of FIG. 1 may correspond to the data driver 143 of FIG. 17.

According to embodiments of the display apparatus, the method of driving the display panel using the display apparatus and the electronic apparatus including the display apparatus, the accuracy of the stress accumulation value may be enhanced such that the accuracy of the deterioration compensation may be enhanced and the display quality of the display panel may be enhanced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel;
a data driver which outputs a data voltage to the display panel; and
a driving controller comprising:
a deterioration compensator which compensates a first input grayscale value based on a stress accumulation value to generate a first output grayscale value; and
a stress accumulator which accumulates the first output grayscale value to generate the stress accumulation value,
wherein the stress accumulator determines the stress accumulation value based on a luminance control mode, a luminance setting value, an on-pixel ratio and the first output grayscale value.

2. The display apparatus of claim 1, wherein the luminance control mode includes a first mode in which the display panel has a constant luminance regardless of the on-pixel ratio at a same luminance setting value and a same input grayscale value.

3. The display apparatus of claim 2, wherein the stress accumulator determines the stress accumulation value based on the luminance setting value and the first output grayscale value and regardless of the on-pixel ratio when the luminance control mode is the first mode.

4. The display apparatus of claim 1, wherein the luminance control mode includes a second mode in which a luminance of the display panel decreases as the on-pixel ratio increases at a same luminance setting value and a same input grayscale value.

5. The display apparatus of claim 4, wherein the stress accumulator determines the stress accumulation value based on the luminance setting value and the first output grayscale value and regardless of the on-pixel ratio when the luminance control mode is the second mode,
wherein the stress accumulator determines the stress accumulation value without applying a weight to the first output grayscale value for a first grayscale range when the luminance control mode is the second mode, and
wherein the stress accumulator determines the stress accumulation value by applying a weight to the first output grayscale value for a second grayscale range having a grayscale value greater than a grayscale value of the first grayscale range when the luminance control mode is the second mode.

6. The display apparatus of claim 1, wherein the luminance control mode includes a third mode in which a luminance of the display panel decreases as the on-pixel ratio increases and a slope of a luminance decrease is varied according to a range of the on-pixel ratio at a same luminance setting value and a same input grayscale value.

7. The display apparatus of claim 6, wherein the luminance decreases as the on-pixel ratio increases at the same luminance setting value and the same input grayscale value for a first on-pixel ratio range when the luminance control mode is the third mode,
wherein the luminance decreases as the on-pixel ratio increases at the same luminance setting value and the same input grayscale value for a second on-pixel ratio range when the luminance control mode is the third mode,
wherein the on-pixel ratio in the second on-pixel ratio range is greater than the on-pixel ratio in the first on-pixel ratio range, and
wherein an absolute value of a second luminance decrease slope in the second on-pixel ratio range is greater than an absolute value of a first luminance decrease slope in the first on-pixel ratio range.

8. The display apparatus of claim 7, wherein the luminance decreases as the on-pixel ratio increases at the same luminance setting value and the same input grayscale value for a third on-pixel ratio range when the luminance control mode is the third mode,
wherein the on-pixel ratio in the third on-pixel ratio range is greater than the on-pixel ratio in the second on-pixel ratio range, and
wherein an absolute value of a third luminance decrease slope in the third on-pixel ratio range is less than the absolute value of the second luminance decrease slope in the second on-pixel ratio range.

9. The display apparatus of claim 6, wherein the display panel has a constant luminance regardless of the on-pixel ratio at the same input grayscale value for a first luminance setting value when the luminance control mode is the third mode,
wherein the luminance of the display panel decreases as the on-pixel ratio increases at the same input grayscale value for a second luminance setting value when the luminance control mode is the third mode,
wherein the second luminance setting value is greater than the first luminance setting value,
wherein a first on-pixel ratio range of the second luminance setting value in the third mode has a first luminance decrease slope, a second on-pixel ratio range of the second luminance setting value in the third mode has a second luminance decrease slope, and a third on-pixel ratio range of the second luminance setting value in the third mode has a third luminance decrease slope,
wherein the on-pixel ratio of the second on-pixel ratio range is greater than the on-pixel ratio of the first on-pixel ratio range, and the on-pixel ratio of the third on-pixel ratio range is greater than the on-pixel ratio of the second on-pixel ratio range, and
wherein an absolute value of the second luminance decrease slope is greater than an absolute value of the first luminance decrease slope, and an absolute value of the third luminance decrease slope is less than the absolute value of the second luminance decrease slope.

10. The display apparatus of claim 6, wherein the stress accumulator determines the stress accumulation value based on a stress profile which is generated based on measured luminance data for a plurality of measuring luminance setting values, a plurality of measuring grayscale values and a plurality of measuring on-pixel ratios.

11. The display apparatus of claim 10, wherein the measured luminance data are measured for three or more measuring luminance setting values, three or more measuring grayscale values and three or more measuring on-pixel ratios.

12. The display apparatus of claim 1, wherein the luminance control mode includes:
a first mode in which the display panel has a constant luminance regardless of the on-pixel ratio at a same luminance setting value and a same input grayscale value;
a second mode in which a luminance of the display panel decreases as the on-pixel ratio increases at the same luminance setting value and the same input grayscale value; and
a third mode in which a luminance of the display panel decreases as the on-pixel ratio increases and a slope of a luminance decrease is varied according to a range of the on-pixel ratio at the same luminance setting value and the same input grayscale value, and
wherein the stress accumulator determines the stress accumulation value based on a first stress profile, which is generated based on first measured luminance data for a plurality of first measuring luminance setting values, a plurality of first measuring grayscale values and a plurality of first measuring on-pixel ratios when the luminance control mode is the first mode.

13. The display apparatus of claim 12, wherein the stress accumulator determines the stress accumulation value based on a second stress profile, which is generated based on second measured luminance data for a plurality of second measuring luminance setting values, a plurality of second measuring grayscale values and a plurality of second measuring on-pixel ratios when the luminance control mode is the second mode.

14. The display apparatus of claim 13, wherein the stress accumulator determines the stress accumulation value based on a third stress profile, which is generated based on third measured luminance data for a plurality of third measuring luminance setting values, a plurality of third measuring grayscale values and a plurality of third measuring on-pixel ratios when the luminance control mode is the third mode.

15. The display apparatus of claim 1, wherein the driving controller further includes a luminance adjuster which compensates a second input grayscale value based on the luminance control mode, the luminance setting value and the on-pixel ratio to output a second output grayscale value.

16. The display apparatus of claim 15, wherein the driving controller further includes an image analyzer which analyzes input image data to determine the on-pixel ratio and which outputs the on-pixel ratio to the stress accumulator and the luminance adjuster.

17. A method of driving a display panel, the method comprising:
compensating a first input grayscale value based on a stress accumulation value to generate a first output grayscale value;
accumulating the first output grayscale value to generate the stress accumulation value;
generating a data voltage based on the first output grayscale value; and
displaying an image based on the data voltage,
wherein the stress accumulation value is determined based on a luminance control mode, a luminance setting value, an on-pixel ratio and the first output grayscale value.

18. The method of claim 17, wherein the luminance control mode includes:
a first mode in which the display panel has a constant luminance regardless of the on-pixel ratio at a same luminance setting value and a same input grayscale value;
a second mode in which a luminance of the display panel decreases as the on-pixel ratio increases at the same luminance setting value and the same input grayscale value; and
a third mode in which a luminance of the display panel decreases as the on-pixel ratio increases and a slope of a luminance decrease is varied according to a range of the on-pixel ratio at the same luminance setting value and the same input grayscale value.

19. The method of claim 18, wherein the stress accumulation value is determined based on the luminance setting value and the first output grayscale value and regardless of the on-pixel ratio when the luminance control mode is the first mode,
wherein the stress accumulation value is determined based on the luminance setting value and the first output grayscale value and regardless of the on-pixel ratio when the luminance control mode is the second mode,
wherein the stress accumulation value is determined without applying a weight to the first output grayscale value for a first grayscale range when the luminance control mode is the second mode,
wherein the stress accumulation value is determined by applying a weight to the first output grayscale value for a second grayscale range having a grayscale value greater than a grayscale value of the first grayscale range when the luminance control mode is the second mode, and
wherein the stress accumulation value is determined based on a stress profile which is generated based on measured luminance data for a plurality of measuring luminance setting values, a plurality of measuring grayscale values and a plurality of measuring on-pixel ratios.

20. An electronic apparatus comprising:
a display panel;
a data driver which outputs a data voltage to the display panel;
a driving controller which controls the data driver; and
a processor which outputs input image data and an input control signal to the driving controller,
wherein the driving controller comprises:
a deterioration compensator which compensates a first input grayscale value based on a stress accumulation value to generate a first output grayscale value; and
a stress accumulator which accumulates the first output grayscale value to generate the stress accumulation value, and
wherein the stress accumulator is which determines the stress accumulation value based on a luminance control mode, a luminance setting value, an on-pixel ratio and the first output grayscale value.
